(19) United States
(12) Patent Application Publication
(10) Pub. No.: US 2007/0124586 A1
(43) Pub. Date: May 31, 2007

(54) Dedicated communication system and dedicated communicating method

(75) Inventor: Daisuke Ochi, Munich (DE)

Correspondence Address: CROWELL & MORING LLP;INTELLECTUAL PROPERTY GROUP, P.O. BOX 14300, WASHINGTON, DC, 20044-4300, US

(73) Assignee: NTT DoCoMo, Inc., Chiyoda-ku (JP)

(21) Appl. No.: 11/521,562

(22) Filed: Sep. 15, 2006

(30) Foreign Application Priority Data
Nov. 30, 2005 (JP) 2005-346318

(51) Int. Cl. H04L 9/00

(52) U.S. Cl. 713/168; 713/162

(57) ABSTRACT

The management of a conversion table of the original address and the dedicated address, and the management of the correspondence between a dedicated address and a communication partner are not necessary, and an original address can be concealed from the communication partner while performing communications by generating a dedicated address for each communication partner. A conversion table and communication partner information are incorporated into a mail address and encrypted to guarantee confidentiality, thereby requiring no management of a conversion table of the original address and the dedicated address, or no management of the correspondence between a dedicated address and a communication partner on the user and mail server sides.

### BACKGROUND OF THE INVENTION

1. Field of the Invention

The present invention relates to a dedicated communication system and a dedicated communicating method, and more specifically to a dedicated communication system and a dedicated communicating method capable of realizing communications by delivering electronic mail for a guarantee of anonymity, VoIP (Voice over IP), etc.

2. Description of the Related Art

Recently, there are an increasing number of problems of spam mail by revealing personal information such as a personal mail address, etc. to a malicious third party. Preventive means against them can be mail filtering. However, the mail filtering often gets into a vicious circle with a spammer, and becomes ineffective, and mail which is to be correctly delivered can be filtered out and may not be delivered. Lately, there has been a method of generating a plurality of temporary dedicated mail addresses to be used for the respective communication partners, thereby designating the revealing source of addresses, rejecting the reception of the corresponding address, thus preventing spam mail.

Conventionally, a plurality of mail addresses can be freely generated using an extended mail address such as qmail, etc. However, in this method, a transmitter can be estimated and an original address can be revealed to a spammer. On the other hand, Address Guard of Yahoo (registered trademark) and privango of NTT (registered trademark) are used with an alias with the original user name concealed. According to JP2003-141042A, a random address is generated, and a dedicated address is issued to the original address.

JP2004-228832A describes the technology of preventing spam mail from being transmitted to a destination by transmitting inquiry information to a transmitter and deleting it when no response is received.

JP2003-186805A describes the technology of storing a conversion table indicating the correspondence among mail, an encryption key, and an ID, and encrypting a mail address using the conversion table.

JP2004-15180A describes the technology of providing an address conversion server for storing each address of a number of members associated with a unique reception permitted domain name, and not transmitting mail to a member when a source domain name does not match a reception permitted domain name.

JP2004-23592A describes the technology of concealing the original mail address by converting a mail address.

### SUMMARY OF THE INVENTION

The above-mentioned technologies of Address Guard, privango, and JP2003-141042A have the feature of high anonymity, but it is necessary to manage all conversion table of dedicated addresses by a mail server. To suppress the pressure of the conversion table by an increasing number of zombie addresses that never appear again, it is necessary for a user to manually generate a dedicated address, and explicitly manage the dedicated address to use it for a specific communication partner.

In the case of the above-mentioned JP2004-228832A, it is necessary to inquire about each piece of mail. Therefore, it is difficult to process mail when a large volume of spam mail is transmitted. In the case of JP2003-186805A, it is necessary to manage a conversion table. JP2004-15180A has no effect when an address has not been registered in advance by a member. In the case of JP2004-23592A, it is necessary to manage an address book corresponding to the conversion table.

(Problem 1)

In the above-mentioned representative conventional technology relating to the dedicated address, the address of an alias name is used to conceal the original address, but a user manually generates the name, manages the conversion table of an original address and a dedicated address, and manages the correspondence between the dedicated address and a communication partner. That is, it is necessary in the conventional technologies to hold in a mail server, etc. the conversion table between a generated address and its original address. If a dedicated address is automatically generated for each communication partner, the number of dedicated addresses that will never be used again explosively increases, and the mail server has to continuously manage the conversion table.

Therefore, the advantage of the present invention is to provide a dedicated mail system and dedicated mail transmitting method capable of eliminating the necessity to manage the conversion table of an original address and a dedicated address and manage the correspondence between the dedicated address and the communication partner on the user and mail server sides by incorporating a conversion table and communication partner information into a mail address, encrypting them, and guaranteeing the confidentiality.

(Problem 2)

In the above-mentioned representative conventional technology relating to the dedicated address, the Address Guard and the privango generate a dedicated address using an alias for replacement of the address of a user. However, since the alias corresponds one to one to the address of the user, the reveal of the correspondence threatens all the other dedicated addresses to be revealed, and newly generated dedicated addresses are also threatened to be revealed.

Therefore, the advantage of the present invention is to provide a dedicated communication system and a dedicated communicating method capable of reducing the influence of the possible reveal of the correspondence between one dedicated address and the address of a user by encrypting and using the address of the user without using an alias corresponding one to one to the address of a user.

The dedicated communication system according to a first aspect of the present invention is a dedicated communication system which converts a communication address received from a communication source into a dedicated address and transmits the dedicated address to a communication destination, and includes: encryption means for encrypting communication partner information about a communication partner together with a communication source address; and dedicated address generation means for generating a dedicated address based on an encryption result from the encryption means. The communication source address is replaced with the dedicated address generated by the dedicated address generation means, and is transmitted to the communication destination. With the configuration, communications can be performed with the original address concealed from a communication partner, and it is not necessary for a mail server to manage the dedicated address. Since it is also not necessary for the user to manage the dedicated address, the anonymity can be guaranteed in almost the same method as the conventional technology in communications. The “address” is a broad concept including an SIP (session initiation protocol) address, etc. in addition to the electronic mail address.

The dedicated communication system according to a second aspect of the present invention is based on the first aspect, and the dedicated address generation means adds a serial number of a private key used in the encryption by the encryption means when the dedicated address is generated. If a dedicated address is generated with a serial number such as version information, etc. added, and communications are performed, then the damage of the possible reveal of an encrypted private key for any reason can be minimized, and the influence of the reveal can be avoided in the future.

The dedicated communication system according to a third aspect of the present invention is based on the first or second aspect, and the dedicated address generation means compresses the communication partner information when the dedicated address is generated. With the configuration, a dedicated address can be shorter than in the case of it being not compressed when it is generated.

The dedicated communicating method according to a fourth aspect of the present invention is a dedicated communicating method for converting a communication address received from a communication source into a dedicated address and transmits the dedicated address to a communication destination, and includes: an encrypting step of encrypting communication partner information about a communication partner together with a communication source address; a dedicated address generating step of generating a dedicated address based on an encryption result obtained in the encrypting step; and a step of replacing the communication source address with the dedicated address generated in the dedicated address generating step, and transmitting the address to the communication destination. With the configuration, communications can be performed with the original address concealed from a communication partner, and it is not necessary for a mail server to manage the dedicated address. Since it is also not necessary for the user to manage the dedicated address, the anonymity can be guaranteed in almost the same method as the conventional technology in communications.

The dedicated communicating method according to a fifth aspect of the present invention is based on the fourth aspect, and in the dedicated address generating step, the serial number of the private key used in the encryption in the encrypting step is added when the dedicated address is generated. If a dedicated address is generated with a serial number such as version information, etc. added, and communications are performed, then it is not necessary to continuously use the same private key, and the damage of the possible reveal of an encrypted private key for any reason can be minimized, and the influence of the reveal can be avoided in the future.

The dedicated communicating method according to a sixth aspect of the present invention is based on the fourth or fifth aspect, and in the dedicated address generating step, the communication partner information is compressed when the dedicated address is generated. With the configuration, a dedicated address can be shorter when it is generated.

According to the present invention, a dedicated address is generated for each communication partner for use in communications, thereby performing the communications while concealing the original address from each communication partner. It is not necessary for a mail server, etc. to manage the dedicated address. Since it is also not necessary for a user to manage a dedicated address, the anonymity can be guaranteed in almost the same method as the conventional technology in communications.

Furthermore, if a dedicated address is generated with a serial number such as version information, etc. added, and communications are performed, and the damage of the possible reveal of an encrypted private key for any reason can be minimized, and the influence of the reveal can be avoided in the future.

### BRIEF DESCRIPTION OF THE DRAWINGS

FIG. 1 is a block diagram showing an example of the configuration of the dedicated mail system according to a mode for embodying the present invention;

FIG. 2 shows the sequence of an example of the operation performed when a user transmits mail in the dedicated mail system shown in FIG. 1;

FIG. 3 shows the related information which can be set in the dedicated address use request field;

FIG. 4 shows the sequence of an example of the operation performed when encryption is performed in the dedicated mail system shown in FIG. 1;

FIG. 5 shows an example of the format of an option;

FIG. 6 shows an example of the format of an option for a valid term;

FIG. 7 shows an example of the format of an option of adding communication partner information;

FIG. 8 shows an example of a format of an option for a ringing tone;

FIG. 9 shows an example of the configuration of the header shown in FIG. 10;

FIG. 10 shows the address converting process in the dedicated mail system shown in FIG. 1;

FIG. 11 shows the sequence of an example of the operation performed when another user returns mail in the dedicated mail system shown in FIG. 1; and

FIG. 12 shows the sequence of an example of the operation performed when a decoding process is performed in the dedicated mail system shown in FIG. 1.

### DETAILED DESCRIPTION OF THE PREFERRED EMBODIMENTS

The mode for embodying the present invention is explained by referring to the attached drawings. In each of the figures referred to in the following explanation, the corresponding portions are identified by the same reference numerals.

(First Dedicated Mail System: Basic Concept)

In the dedicated mail system according to the present invention, an address conversion device (hereinafter appropriately referred to as an “MAC”: Mail Address Converter) is arranged near the mail delivery device (hereinafter appropriately referred to as an “MTA”: Mail Transfer Agent) in order to solve the above-mentioned problem 1. A mail delivery device can also function as an address conversion device. A mail delivery device is classified as a device explained as a mail server in the conventional technology.

A transmitter A uses a mail client device (hereinafter appropriately referred to as an “MUA” (Mail User Agent). It is obtained by reforming an existing mail client device, and has a setting of a selection as to whether or not a dedicated address is used. When a dedicated address is used, the mail client device describes an instruction to use a dedicated address and related information in the mail header when mail is transmitted to the mail delivery device (hereinafter referred to as a dedicated address use request field). The related information can be “using the contents of a To field as communication partner information”, etc.

The mail delivery device which receives mail analyzes the header. When it confirms the use of a dedicated address, it notifies the address conversion device of the information about the communication partner B and the information (hereinafter referred to as encryption information) required to generate a private key for encryption.

The address conversion device generates or acquires a private key, encrypts an address of transmitter A and communication partner information, and returns a part of the dedicated address to the mail delivery device.

Since it is hard to understand at a glance whose address a dedicated address is, the mail delivery device can add alias information regardless of the delivery. Furthermore, the mail delivery device adds information about the mail delivery device itself (information after “@”), adds to the header the identifier (hereinafter referred to as a dedicated address identifier, for example, an underline “_”) indicating the dedicated address, thereby generating a dedicated address. The address is replaced with the address of the transmitter A described in the transmitter information such as a From field, etc., and a dedicated address use request field is removed from the mail header. Then, the mail delivery device delivers the mail to the communication partner B described in the destination field such as a To field.

No special system or device but a conventional mail system is required for the communication partner B. The communication partner B can return mail to the dedicated address of the transmitter by a return button, etc.

The mail transmitted by the communication partner B reaches the mail delivery device of the original transmitter A. The mail delivery device checks the destination address, and if the address refers to the dedicated address identifier, then an encrypted portion is retrieved and passed to the address conversion device. The address conversion device decodes the address of transmitter A, that is, the original destination and the communication partner information, from the portion, and returns it to the mail delivery device.

The mail delivery device can verify the address of the communication partner B, that is, the transmitter of the mail if necessary. Then, the dedicated address described as the destination in the mail header is rewritten to the original destination address of the transmitter A, and the information that the mail has been transmitted to the dedicated address (hereinafter referred to as a dedicated address use request field) is added to the mail header and delivered to a corresponding mail box.

Thus, mail can be communicated with the communication partner B with the original address of the transmitter A concealed. At this time, it is not necessary for any of the mail client device, the mail delivery device, and the address conversion device to manage the conversion table between the original address of the transmitter A and the dedicated addresses. Furthermore, it is necessary for no device to manage the correspondence between a dedicated address and a communication partner B.

Although the mail delivery device has to hold encryption information, it holds the information commonly for all subordinate users. Furthermore, it is also possible that the mail delivery device does not transmit the encryption information to the address conversion device for each encryption and decryption, but the address conversion device temporarily stores the information.

In addition, when whole mail address of the communication partner B is encrypted and incorporated as communication partner information in the dedicated address, the dedicated address can be too long. Therefore, a hash value is calculated with an appropriate length from the mail address of the communication partner B, represented by an irreversible code, and used as the communication partner information. That is, the communication partner information can be compressed and the address length can be suppressed. The determination can be described in the dedicated address use request field.

When mail is received from the communication partner B, it can be verified whether or not the communication partner information refer to the communication partner B. It can be specified in the dedicated address use request field. The information can be incorporated into the encrypted dedicated address.

It is not necessary that the communication partner information always refers to the mail address of the communication partner B, but the any information can be used. For example, when the communication partner B also uses a dedicated address, the transmitter A first uses any information as communication partner information, generates a dedicated address as the communication partner information not to be verified, and publishes it to the communication partner B. To the address, the communication partner B generates a dedicated address and transmits mail.

When a dedicated address is shared in a group, all group members can share the dedicated address by generating a dedicated address which is set as communication partner information not to be verified and uses the identification information (mailing address, etc.) about the group as the communication partner information without generating a dedicated address for each group member.

Furthermore, various information can be optionally added to the encrypted contents in addition to the address of the transmitter A and the communication partner information about the communication partner B. For example, an option of setting a valid term can be added. Additionally, when a dedicated address is used for a plurality of communication partners, there are an option of describing communication partners in addition to the communication partner information, an option of setting a tone to be raised when mail is received from the communication partner B, etc. The options can be set as a daisy chain.

(Second Dedicated Mail System: Countermeasure Against Reveal)

To solve the above-mentioned problem 2, the conversion algorithm of the address conversion device in the first dedicated mail system is partially specified.

The mail delivery device of the first dedicated mail system holds encryption information for each mail delivery device. The address conversion device encrypts the address of the transmitter A (contents before “@”) and the communication partner information based on the generated private key. Thus, when the communication partner B receives a dedicated address, the original address of the transmitter A is concealed. In the first dedicated mail system, the transmitter A can add an alias of any characters, but since it does not correspond one to one to the address, the second problem does not occur. However, when a private key is revealed, the original address is also revealed, and the problem similar to that of the problem 2 occurs.

To solve the problem, in the second dedicated mail system, the encryption information is specified as a combination of seed information for generating random number (hereinafter referred to as seed information) or a private key itself and its version information. The mail delivery device can recognize a private key from the version information. The implementing method can be, for example, managing a private key for each version and using a private key corresponding to version information. Otherwise, the method can be generating a private key using the n-th random number generated from the seed information when the version information is “n”.

The address conversion device adds version information after performing an encrypting process based on a private key. When a decoding process is performed, a corresponding private key is first detected from the version information, and then the decoding process is performed.

Thus, it is not necessary to constantly use the same private key, and although a private key is revealed, the range of the influence is limited to the use of the same version. Then, by changing the version information, there is no influence of the reveal on a newly generated dedicated address. The seed information and the private key information are stored in the mail delivery device and shared by all subordinate users, but the version information can be separately assigned to each user by the mail delivery device, and the user can also directly specify the version information. The case in which version information is used is described above, but the present invention is not limited to the case, and any serial number can be used.

In the conventional technology, when an original address corresponding to an alias is once revealed, there is the risk that the original address will be revealed in the future because it is necessary to use the same alias for a dedicated address to be newly generated. However, in the second dedicated mail system, the possibility can be suppressed.

A mail address is exclusively explained above, but an address such as an SIP address, etc. which has a style similar to that of the mail address and is used for identification of a person can also be converted and managed in the same way.

### EMBODIMENTS

An embodiment of the dedicated mail system according to the present invention is explained by referring to the attached drawings. In the present embodiment, the function of a mail delivery device and the function of an address conversion device are implemented in the same device.

(Example of System Configuration)

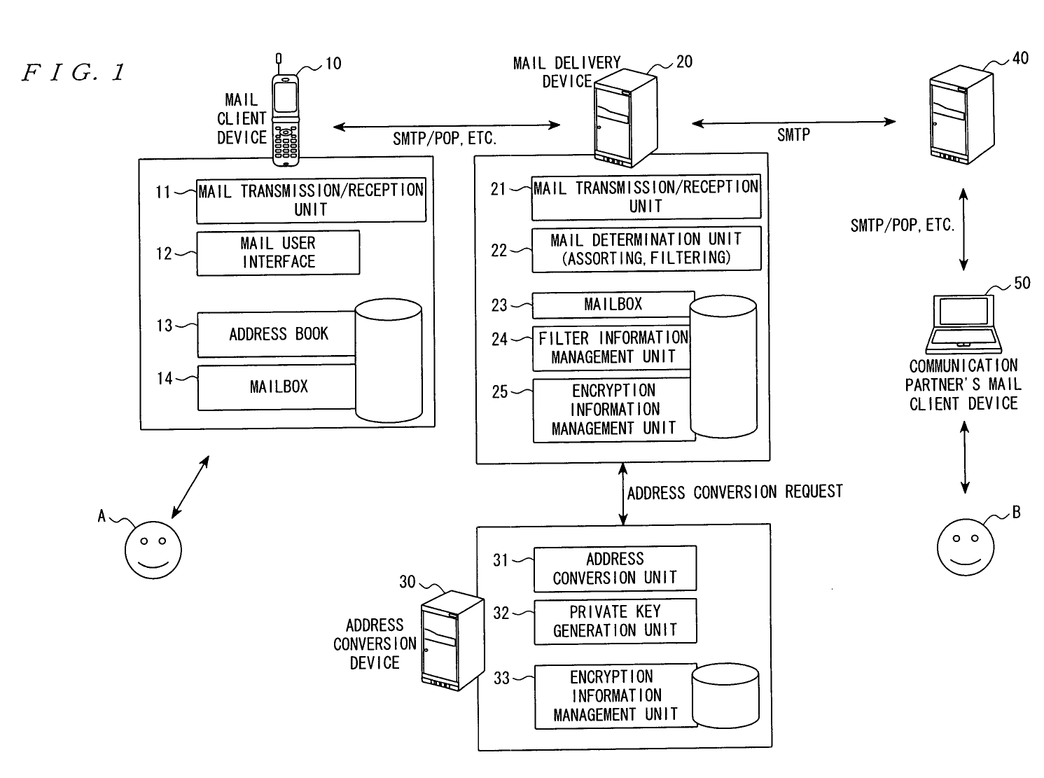

FIG. 1 is a block diagram showing an example of the configuration of the dedicated mail system according to the present invention. In FIG. 1, the dedicated mail system according to present embodiment includes: a mail client device 10 such as a mobile terminal, etc., a mail delivery device 20, an address conversion device 30, another mail delivery device 40, and a communication partner's mail client device 50 such as a notebook-size computer, etc. A well-known SMTP (simple mail transfer protocol)/POP (post office protocol), etc. are used for communications between the mail client device 10 and the mail delivery device 20. A well-known SMTP is used for communications between the mail delivery device 20 and the mail delivery device 40. The communications between the mail delivery device 40 and the communication partner's mail client device 50 are performed by a well known SMTP/POP, etc.

The mail client device 10 includes a mail transmission/reception unit 11 for transmitting and receiving mail, a mail user interface 12 for performing a mail transmitting and receiving operation, etc., an address book 13 for management of a mail address of a communication partner, and a mailbox 14 for storing transmitted and received mail. The address book 13 and the mailbox 14 are stored in semiconductor memory or a well known storage device. The communication partner's mail client device 50 has a configuration similar to the configuration of the mail client device 10.

The mail delivery device 20 includes a mail transmission/reception unit 21 for transmitting and receiving mail, a mail determination unit 22 for assorting and filtering mail, a mailbox 23 for storing transmitted and received mail, a filter information management unit 24 for managing filter information, and an encryption information management unit 25 for managing encryption information. The mail delivery device 40 has the same configuration as that of the mail delivery device 20 except the filter information management unit 24 and the encryption information management unit 25.

The address conversion device 30 includes an address conversion unit 31 for converting a mail address, a private key generation unit 32 for generating a private key, and an encryption information management unit 33 for managing encryption information.

In the present embodiment, an operation example will be described for a case that a transmitter A as a user who uses the mail client device 10 transmits mail to a communication partner B as a user who uses the communication partner's mail client device 50, and the communication partner B returns mail to the transmitter A.

(Transmitting Mail)

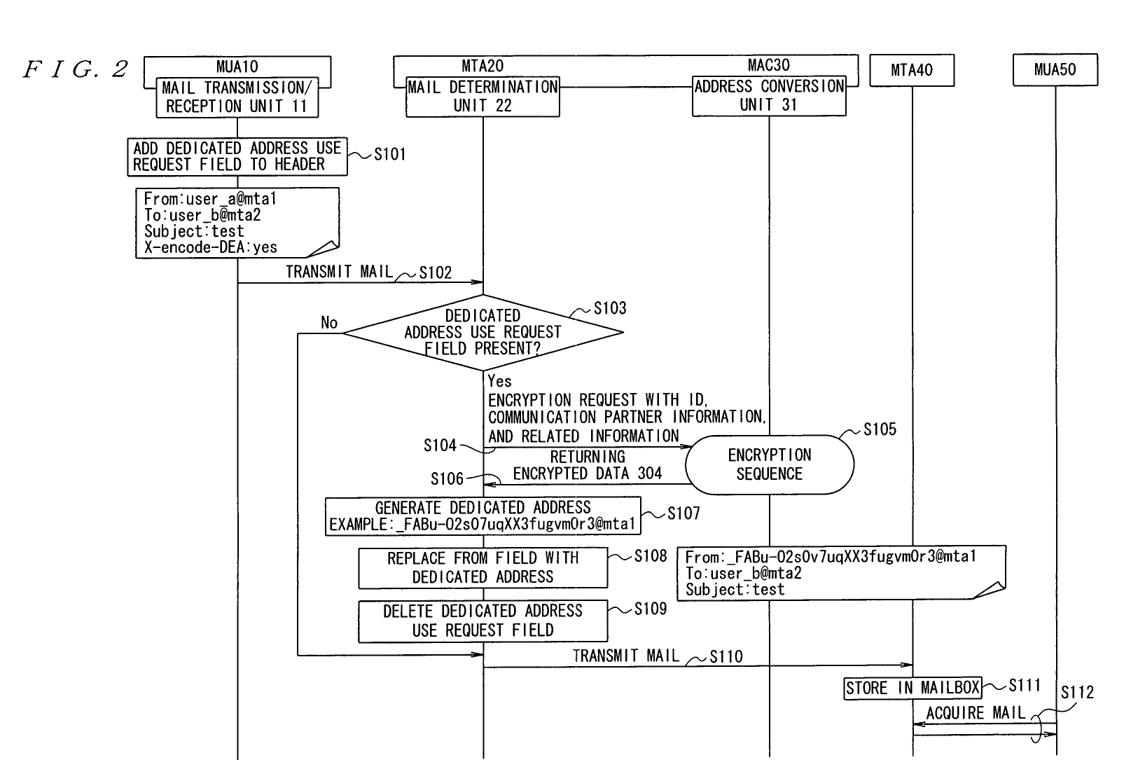

An example of an operation of transmitting mail by the dedicated mail system according to the present mode for embodying the present invention is explained below by referring to FIG. 2. FIG. 2 shows the sequence of an example of the operation performed when a transmitter A transmits mail to a communication partner B using the mail client device 10.

In FIG. 2, the transmitter A makes a setting of transmitting mail using a dedicated address through the mail user interface 12 or the address book 13. For example, there is a method of the transmitter A indicating a check mark in a check box using the mail user interface 12, or a method of describing the presence/absence of a use of a dedicated address for each communication partner using the address book 13, and automatically indicating the correspondence between them.

When the transmitter A issues an instruction to transmit mail, the mail transmission/reception unit 11 of the MUA 10 adds a “dedicated address use request field” to a mail header (step S101). For example, the following setting is made using the field name X-encode-DEA.

X-encode-DEA: yes; Expire=Dec. 2002 12: 52:35+0900: Verify=off

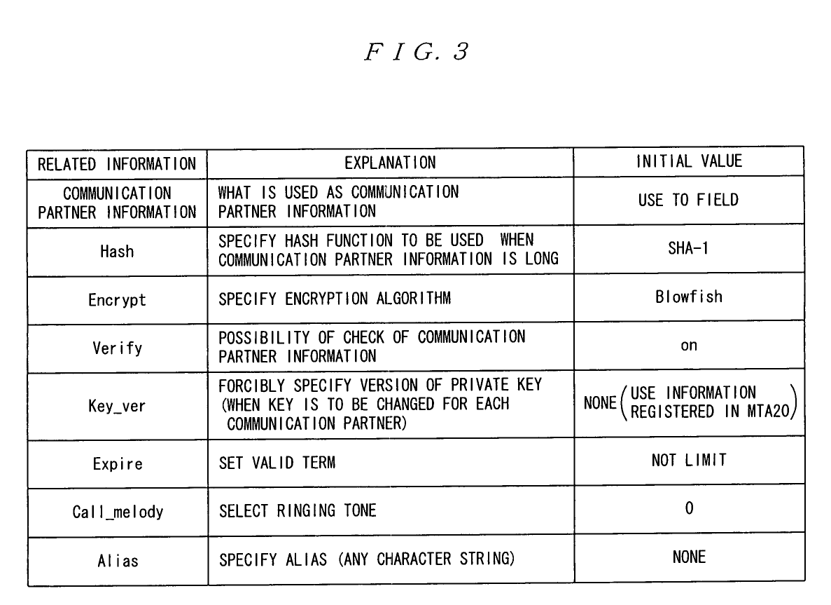

Plural pieces of related information can be set in the “dedicated address use request field”. For example, the information shown in FIG. 3 can be set.

The mail transmission/reception unit 11 transmits mail to the MTA 20 (step S102).

Upon receipt of mail by the mail transmission/reception unit 11, the MTA 20 confirms the contents of the mail header by the mail determination unit 22. At this time, it confirms the presence/absence of the “dedicated address use request field” (step S103). If there is no dedicated address use request field as a result of the confirmation, the mail is normally transmitted as is (steps S103 to S110), and stored in the mailbox (step S111). Thus, the communication partner B can normally receive mail from the transmitter A (step S112).

On the other hand, if there is a dedicated address use request field as a result of the confirmation in step S103, the related information is read and control is passed to the process of generating a dedicated address.

In generating a dedicated address, an original mail address 300 of the transmitter A is first obtained from the From field of the mail header, and divided into an ID (3001) and a host name (3002). Unless otherwise specified in the related information, the address of the communication partner B in the To field is used as communication partner information. Then, the ID, the communication partner information, and the related information are passed to the address conversion unit 31 of the MAC 30 (steps S103 and S104). In this example, the functions of the MTA 20 and the MAC 30 are implemented in the same device.

Then, the address conversion unit 31 performs an encrypting process. The encryption sequence (step S105) of the address conversion unit 31 is described later. The address conversion unit 31 returns encrypted data 304 to the mail determination unit 22 (step S106).

Upon receipt of the data 304, the mail determination unit 22 generates a dedicated address (step S107). In the present example, an underline “_” as an identifier indicating a dedicated address is added to the head of the data, and an at mark “@” and a host name 3002 are added to the end of the data. When an alias is specified in the related information a period “.” and an alias character string are inserted between the data 304 and the at mark “@”. Thus, a dedicated address is generated. The mail delivery device 20 provides a normal mail address with a restriction such that the leading character is a character other than the underline“_”.

The mail determination unit 22 replaces the original mail address 300 of the transmitter A described in the From field of the original mail with a dedicated address (step S108), and deletes the “dedicated address use request field” in the header (step S109). Then, the mail is delivered to the mail delivery device 40 of the communication partner B through the mail transmission/reception unit 21 (step S110), and stored in the mailbox (step S111). Thus, the communication partner B can receive from the transmitter A the mail concealed by the dedicated address (step S112).

(Encryption Sequence)

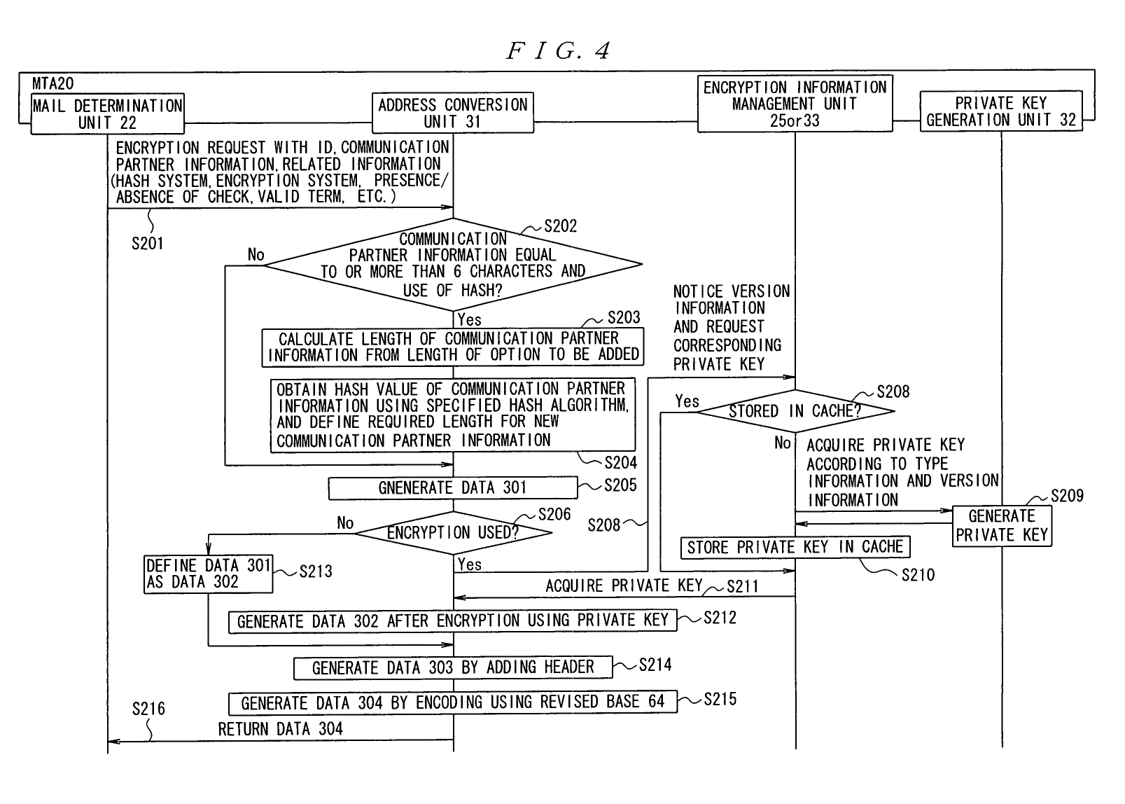

Next, the encryption sequence by the address conversion unit 31 (step S105) used in the sequence shown in FIG. 2 is explained by referring to FIG. 4.

The address conversion unit 31 acquires the ID (3001) of the transmitter A added to the encryption request, the communication partner information, and the related information from the mail determination unit 22 (step S201). The acquired related information is described in the “dedicated address use request field” including a hash system, an encryption system, possibility of a verification, key version information, valid term, etc.

The address conversion unit 31 determines according to related information whether or not a hash is used (step S202). In this example, when a hash is used and the communication partner information is equal to or more than a predetermined number of bytes (for example, 6 bytes), a desired hash value of the communication partner information is calculated. When a desired hash value is calculated, the length of the communication partner information is calculated from the length of an added option (step S203). In this example, at least 6 bytes are used for a desired hash value, and the length of the desired hash value is determined such that the entire length of the data 301 can be the length of a multiple of a predetermined number−1 (for example, 7, 15, 23, . . . , 8n−1 when “Blowfish” is used in the analysis algorithm) when data 301 is generated. In this example, the desired hash length is 9 bytes. Next, a hash algorithm is selected from the related information, and the hash value of the communication partner information is calculated (step S204). For example, when SHA-1 is used, the hash value is 20 bytes. In the leading bytes, a desired hash length is used as new communication partner information.

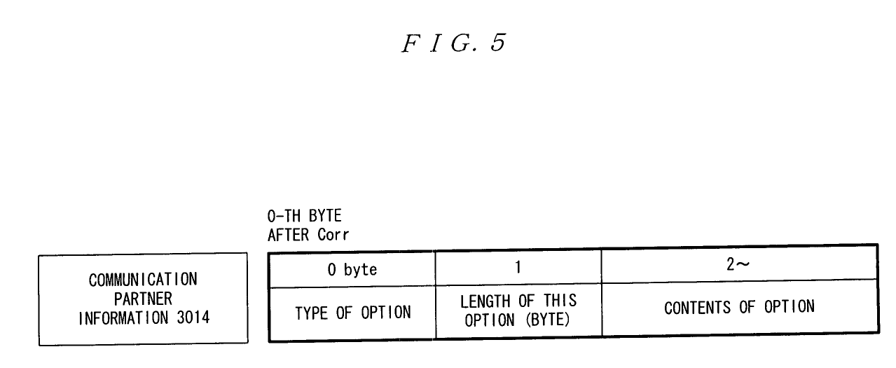

When the communication partner information is determined, it is added to the ID (3001) and communication partner information 3013, and other necessary related information is combined as an option, and the data 301 is generated (step S205). In step S202 described above, when a hash is not used, the data 301 is generated as is. An option to be combined is described in a format as shown in FIG. 5. That is, it is described in the format constituted by a “type of option”, a “length of an option”, and “contents of an option”.

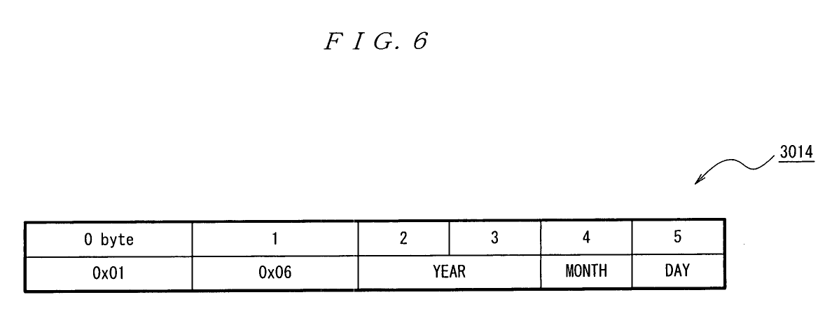

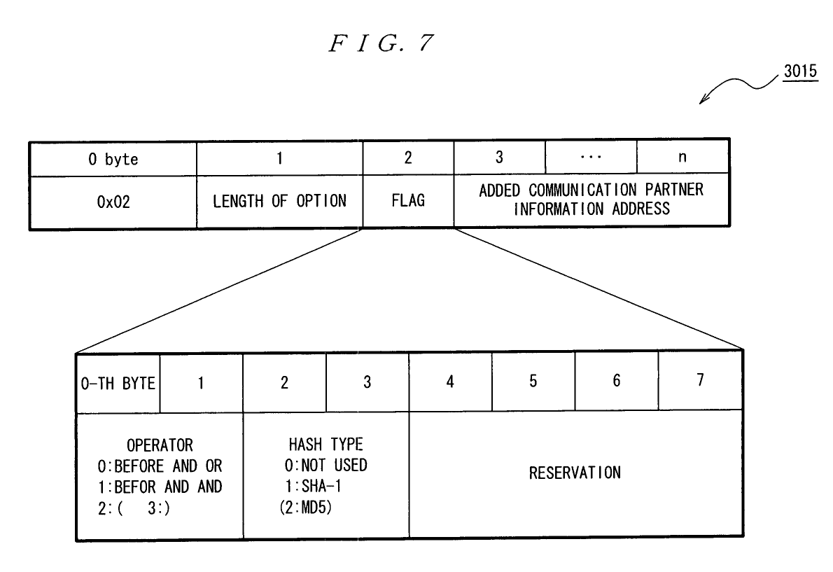

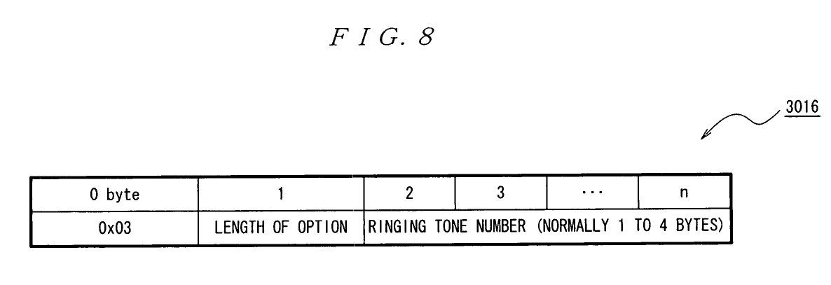

The option can be, for example, a valid term option 3014 (FIG. 6), a communication partner information additional option 3015 (FIG. 7), and a ringing tone option 3016 (FIG. 8) as shown in FIGS. 6 to 8. These options can be described after the communication partner information 3014 shown in FIG. 5.

Back in FIG. 4, the address conversion unit 31 checks the encryption algorithm according to the related information (step S206). If the encryption is required, a private key is requested to the encryption information management unit 25 (the encryption information management unit 33 has the same function) according to the encryption system and the version information (step S207). The encryption information management unit 25 first checks whether or not there is a private key in the cache (temporary storage of a key) (step S208). If there is a private key in the cache, the private key is returned to the address conversion unit 31 (steps S208 to S211).

On the other hand, if there is no private key in the cache, the seed information and the version information in the encryption information management unit 25 are passed to the private key generation unit 32, and the encryption information management unit 25 acquires the private key generated by the private key generation unit 32 (step S209). The private key acquired by the encryption information management unit 25 is temporarily stored in the cache (step S210), and the private key is passed to the address conversion unit 31 (steps S210 to S211).

The seed information is managed by the encryption information management unit 25 of the MTA 20, and shared by all subordinate users. The version information can be separately assigned to all subordinate users. The transmitter A can explicitly specify the version information in the dedicated address use request field.

Then, the address conversion unit 31 encrypts the data 301 using an acquired private key, and generates data 302 (step S212). If the encryption is not required in step S206, the data 301 is used as the data 302 as is (step S213).

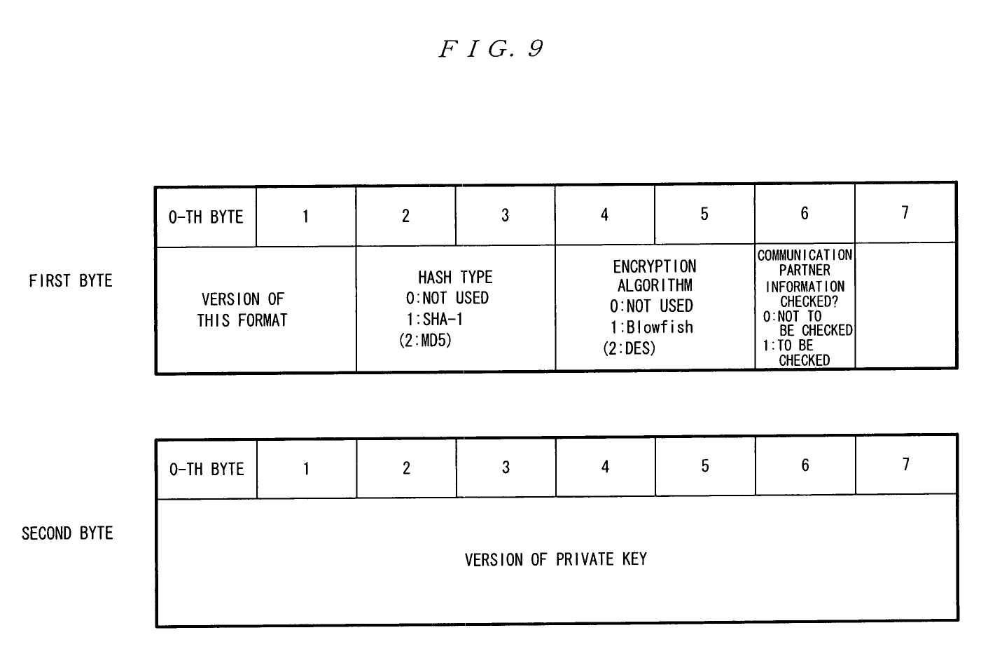

Then, a 2-byte header 3031 is added to the generated data 302, there by generating data 303 (step S214). The header 3031 has a format as shown in FIG. 9, and stores necessary related information.

Back in FIG. 4, the data 303 is a byte string, and cannot be represented in a character string. Therefore, the data is encoded by the well known Base 64 and converted into a character string (step S215). Since a character which cannot be represented in a mail address or URL is not used, “+” is converted into “−”, and “/” is converted into “_” after the coding by Base 64. Thus, data 304 can be generated.

The address conversion unit 31 returns the data 304 to the mail determination unit 22 (step S216).

(Data in the Converting Process)

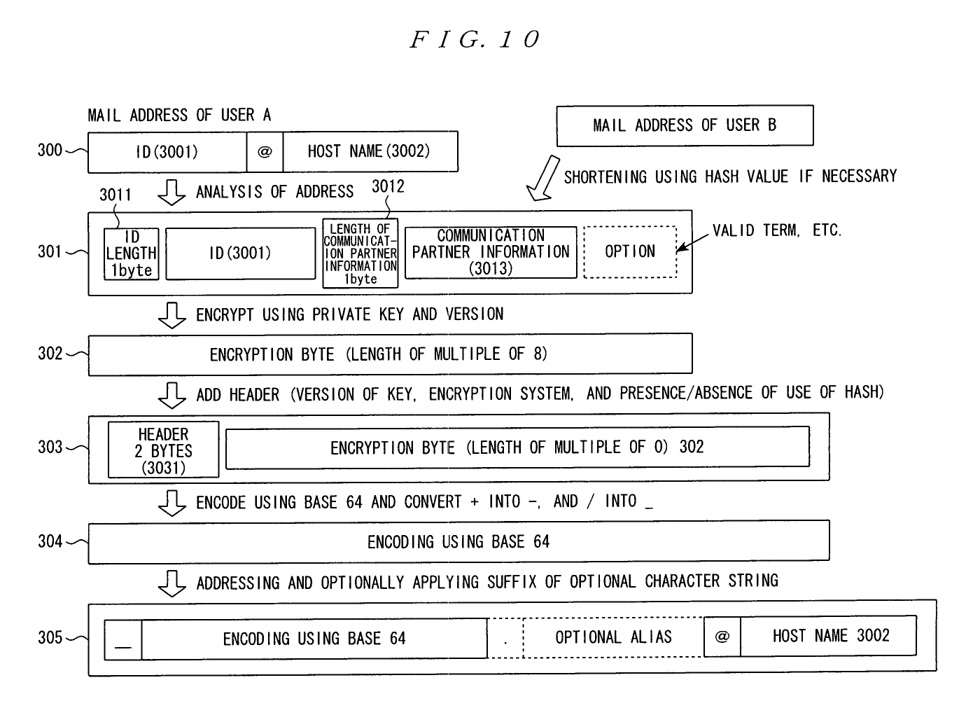

The type, etc. of data generated in the above-mentioned converting process is shown in FIG. 10. That is, the mail address 300 of the transmitter A is analyzed into the ID (3001) and the host name (3002), thereby generating the data 301. The private key and the version information as a serial number are input and encrypted. Thus, the encrypted data 302 is generated. Furthermore, the data 303 is generated by adding the key version information, the encryption system, and the header 3031 indicating the presence/absence of the hash use.

The data 303 is encoded by the well known Base 64, “+” is converted into “−”, and “/” is converted into “_”, thereby generating the data 304. The underline “_” is added to the head of the data 304, the host name 302 and the at mark “@” are added to the end of the data, a period “.” and an alias character string are inserted between the data 304 and the at mark “@” when the alias is specified in the related information, thus data 305 as a dedicated address is generated.

(Reception of Mail)

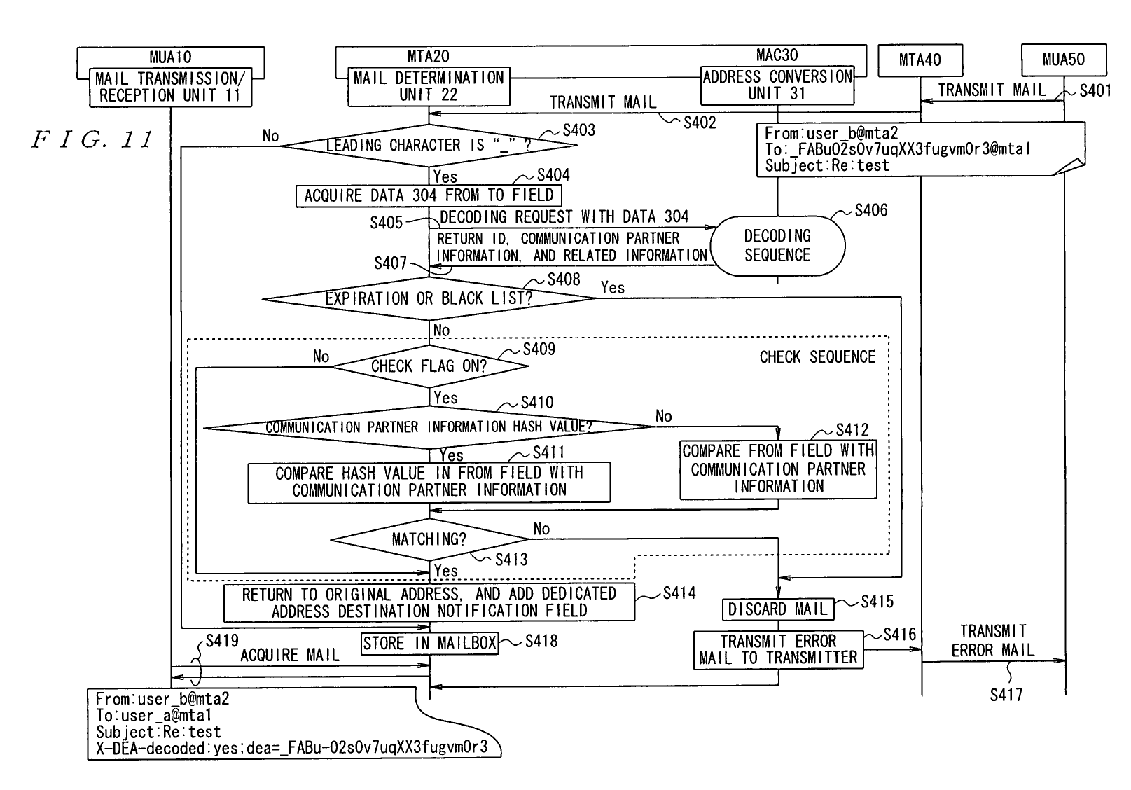

FIG. 11 shows a sequence of the operation of the transmitter A receiving returned mail to a dedicated address from the communication partner B.

In FIG. 11, the communication partner B first transmits mail from the mail client device 50 to the dedicated address of the transmitter A (step S401). The mail is delivered to the MTA 20 through the mail delivery device 40 (step S402).

The mail determination unit 22 of the MTA 20 acquires the data 305 from the To field of the mail header. It is checked whether or not the leading character of the data 305 is the underline “_” as an identifier of the dedicated address (step S403). If the leading character is an underline “_”, it is recognized as a dedicated address, and the reading operation is started.

The reading operation of a dedicated address is performed as follows. First, unnecessary information for the reading operation is removed from the data 305, and the data 304 is obtained (steps S403 to S404). Then, the data 304 is passed to the address conversion unit 31, and the address conversion unit 31 is instructed to decode the data (step S405). Based on the decoding sequence (step S406) described later, the address conversion unit 31 acquires the ID (3001), the communication partner information, and the related information, and passes them to the mail determination unit 22 (step S407).

The mail determination unit 22 then compares a black list for each ID (3001) stored in the filter information management unit with the data 304 in the To field (step S408). If it is described in the black list, the mail is discarded (steps S408 to S415), and error mail is returned to the communication partner B (steps S416 and S417). The black list is dedicated addresses discarded by the transmitter A. When a dedicated address is revealed by a spammer, etc, the black list is used to stop the use of the dedicated address. The valid term of the dedicated address is checked (step S408), the mail is discarded when the validity expires (steps S408 to S415), and error mail is returned to the communication partner B (steps S416 and S417).

When the black list check and the valid term check are satisfied, the decoded related information is checked, and the verification possibility flag is confirmed (steps S408 to S409). If the flag is not set (when the flag is OFF), the verification sequence is bypassed (steps S408 to S414).

When the flag is set (when the flag is ON), the communication partner information 3013 obtained by decoding is compared with the data in the From field. If the use of a hash is indicated according to the related information, the hash value in the From field is calculated with the specified algorithm, and it is confirmed whether or not the matching is obtained in the range of the same length as the communication partner information 3013 (steps S410 to S411). If no hash is used, the communication partner information 3013 is compared with the From field as is (steps S410 to S412). If the comparison result indicates a non-matching result, it is determined that the address is illegally used, the mail is discarded, and error mail is transmitted to the communication partner B (steps S413 to S416, and S417).

If the verification indicates a matching result, it is determined that the received mail is transmitted from an authorized communication partner B, and the dedicated address in the To field is replaced with the original mail address 300 of the transmitter A (steps S413 to S414). Simultaneously, the “dedicated address destination notification field” is added to the mail header. The field is described as follows, for example.

X-DEA-decoded: yes; dea=#FABu-02s0v7uqXX3fugvm0r3

The information before the at mark “@” is described for the dea option of the field in the used dedicated address.

Afterwards, the mail determination unit 22 stores the mail in the mailbox of the transmitter A (step S418), and the transmitter A can receive the mail by the mail client device 10 (step S419).

Thus, the transmitter A can communicate with the communication partner B while concealing its own original mail address 300.

In step S403, when the leading character of the data 305 starts with a character other than an underline “_”, it is recognized as a user address, and is stored in the mailbox (steps S403 to S418). Thus, the transmitter A can receive mail in the MUA 10 (step S419).

(Decoding Sequence)

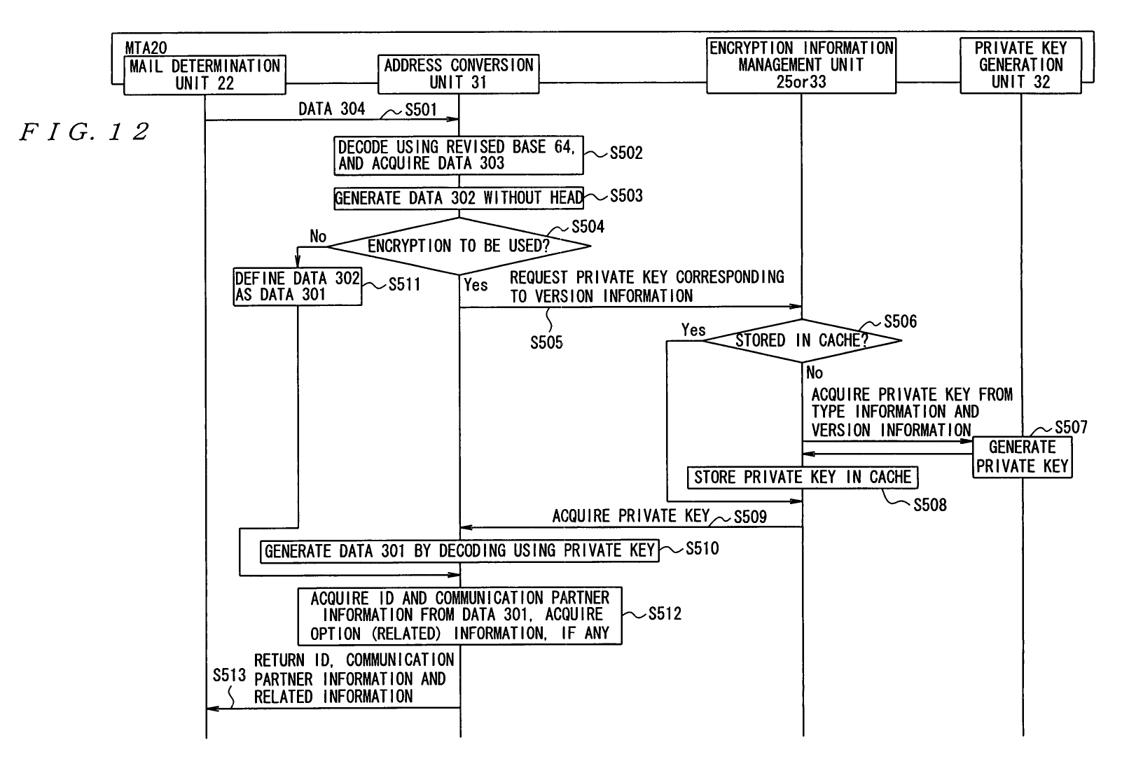

FIG. 12 shows a sequence showing an example of the process contents of the decoding sequence (step S406) by the address conversion unit 31 used in the sequence shown in FIG. 11.

In FIG. 12, the address conversion unit 31 acquires the data 304 from the mail determination unit 22 (step S501). Since the data 304 is encoded with an arrangement to the well known Base 64, the decoding of the Base 64 is performed after first converting “−” into “+” and “_” into “/”, to thereby obtain the data 303 (step S502). Then, the encryption system, the hash system, the possibility of the verification, and the version information are acquired as related information from the header 3031 of the data 303, and the data 302 of the byte string excluding the two leading bytes is acquired (step S503).

Next, when the data 302 is encrypted, the address conversion unit 31 request the encryption information management unit 25 (having the same function as the encryption information management unit 33) for a private key according to the encryption system acquired from the header 3031 and the version information (steps S504 to S505). The encryption information management unit 25 first checks whether or not there is a private key in the cache (temporary storage of a key) (step S506). If there is a private key in the cache, the private key is returned to the address conversion unit 31 (steps S506 to S509).

On the other hand, if there is no private key in the cache, the seed information and the version information in the encryption information management unit 25 are passed to the private key generation unit 32, and the encryption information management unit 25 acquires the private key generated by the private key generation unit 32 (step S507). The private key acquired by the encryption information management unit 25 is temporarily stored in the cache (step S508), and the private key is passed to the address conversion unit 31 (steps S508 to S509).

The address conversion unit 31 decodes the data 302 using the acquired private key, and acquires the data 301 (step S510). If it is determined in step S504 that encryption is not used, the data 302 is used as the data 301 as is (steps S504 to S511).

The address conversion unit 31 acquires ID (3001), the communication partner information 3013 and the related information including the option information and valid term (step S512), and passes the information to the mail determination unit 22 (step S513). Thus, the information such as an ID, etc. can be restored from the dedicated address.

In the above-mentioned sequence, the transmitter A automatically generates a dedicated address from the original mail address 300, and discloses it to the communication partner B, thereby communicating with the communication partner B while concealing the original mail address 300. It is not necessary for the mail delivery device 20 and the transmitter A to manage the conversion between the original mail address 300 and the dedicated address, and the MTA 20 only has to manage the seed information by the encryption information management unit 25. Furthermore, it is not necessary for the MTA 20 and the transmitter A to manage the correspondence that a dedicated address is for the communication partner B.

Since the version information can be optionally changed by dividing the encryption information into the seed information and the version information, the damage of the possible reveal of the information for guarantee of anonymity can be minimized, and the influence of the reveal can be avoided in the future more correctly than in the conventional technology.

(Mail Delivering Method)

In the above-mentioned dedicated mail system, the following dedicated mail transmitting method is realized. That is, it is a dedicated mail transmitting method for transmitting an address of mail received from a mail source to a mail destination after converting the address into a dedicated address, and realized by: an encrypting step of encrypting communication partner information about a communication partner together with a communication source address; a dedicated address generating step of generating a dedicated address based on an encryption result obtained in the encrypting step; and a step of converting the mail source address into a dedicated address generated in the dedicated address generating step, and transmitting it to the mail destination. Thus, the original address can be concealed from a communication partner during the communications, and it is not necessary for a mail server to manage the dedicated address. Since it is also not necessary for a user to manage the dedicated address, the anonymity can be guaranteed during the communication in almost the same method as in the conventional technology.

In the above-mentioned dedicated address generating step, a serial number of a private key used in the encryption in the encrypting step can be added when the dedicated address is generated. If a dedicated address is generated with a serial number such as version information, etc. added, and communications are performed, then the damage of the possible reveal of an encrypted private key for any reason can be minimized, and the influence of the reveal can be avoided in the future.

In the above-mentioned dedicated address generating step, the communication partner information can be compressed when the dedicated address is generated. Thus, a dedicated address can be prevented from being too long when it is generated.

The present invention can be used when data transmission and reception are performed with the anonymity guaranteed.

1. A dedicated communication system which converts a communication address received from a communication source into a dedicated address and transmits the dedicated address to a communication destination, comprising:
encryption means for encrypting communication partner information about a communication partner together with a communication source address; and
dedicated address generation means for generating a dedicated address based on an encryption result from the encryption means, wherein
the communication source address is replaced with the dedicated address generated by the dedicated address generation means, and is transmitted to the communication destination.

2. The dedicated communication system according to claim 1, wherein
the dedicated address generation means adds a serial number of a private key used in the encryption by the encryption means when the dedicated address is generated.

3. The dedicated communication system according to claim 1, wherein
the dedicated address generation means compresses the communication partner information when the dedicated address is generated.

4. A dedicated communicating method for converting a communication address received from a communication source into a dedicated address and transmits the dedicated address to a communication destination, comprising:
an encrypting step of encrypting communication partner information about a communication partner together with a communication source address;
a dedicated address generating step of generating a dedicated address based on an encryption result obtained in the encrypting step; and
a step of replacing the communication source address with the dedicated address generated in the dedicated address generating step, and transmitting the address to the communication destination.

5. The dedicated communicating method according to claim 4, wherein
in the dedicated address generating step, the serial number of the private key used in the encryption in the encrypting step is added when the dedicated address is generated.

6. The dedicated communicating method according to claim 4, wherein
in the dedicated address generating step, the communication partner information is compressed when the dedicated address is generated.

7. The dedicated communication system according to claim 2, wherein
the dedicated address generation means compresses the communication partner information when the dedicated address is generated.

8. The dedicated communicating method according to claim 5, wherein
in the dedicated address generating step, the communication partner information is compressed when the dedicated address is generated.
